(19) United States
(12) Patent Application Publication
(10) Pub. No.: US 2025/0018462 A1
(43) Pub. Date: Jan. 16, 2025

(54) PROCESSING CHAINS

(71) Applicant: Stephen Eudey, Boronia (AU)

(72) Inventor: Stephen Eudey, Boronia (AU)

(21) Appl. No.: 18/714,090

(22) PCT Filed: Dec. 3, 2021
(86) PCT No.: PCT/AU2021/051444

§ 371 Date: May 28, 2024

(51) Int. Cl. B21L 9/06; B25B 27/22

(52) U.S. Cl. CPC B21L 9/065; B25B 27/22

(57) ABSTRACT

An apparatus 1 for processing chain C. The chain comprises links L₁, L₂, L₃ mutually connected by pin portions R. The apparatus comprises a chain holder 3 (to hold the chain) and a pin disengager 5 (operable to remove one of the pin-members to disconnect a portion of the chain from a remainder of the chain). The pin disengager is positioned, or positionable, relative to the chain holder to define a length of the portion of the chain.

### FIELD OF THE INVENTION

The invention relates to processing chains.

The technology disclosed herein is described with reference to chainsaw chains by way of example only. Some variants of the technology may be applied in relation to other chains such as bicycle and motorcycle chains.

### BACKGROUND TO THE INVENTION

FIG. 1 shows a portion of a chainsaw chain C comprising links L₁, L₂, L₃, L₄. Lengthwise adjacent links are mutually connected via pin portions in the form of rivets R.

Chainsaw chain is often supplied in large, e.g. 100 foot, reels. To process this continuous length of chain for use in a chainsaw, firstly a chain portion of the requisite length must be parted off. This is conventionally achieved by counting links starting at the free end of the continuous length of chain. A small chainsaw might have 44 links whereas a large chainsaw may have more than 100 links. After the requisite number of links have been counted up, a pin disengager known as a ‘chainbreaker’ is used to remove the rivets at each end of one pair of connecting links L₄ so as to disconnect the requisite length of chain from the continuous roll.

Counting links is slow, tedious and prone to error. It is not uncommon for chain to be wasted because it has been cut down to the wrong length as a result of miscounting.

Once a chain portion of appropriate length has been parted off, its free ends are brought together and mutually connected using a joining link comprising a respective pin portion for each of the two free ends. The ends of the pin portions are flared to prevent reversal. Typically the ends of the pin portions are flared using a rivet spinner.

The present invention aims to provide improvements in and for processing chains or at least to provide an alternative for those concerned with processing chains.

It is not admitted that any of the information in this patent specification is common general knowledge, or that the person skilled in the art could be reasonably expected to ascertain or understand it, regard it as relevant or combine it in any way before the priority date.

### SUMMARY

One aspect of the invention provides an apparatus for processing chain;

the chain comprising links mutually connected by pin portions;

the apparatus comprising
a chain holder to hold the chain; and
a pin disengager operable to disengage one or more of the pin portions to disconnect a portion of the chain from a remainder of the chain;

wherein the pin disengager is positioned, or positionable, relative to the chain holder to define a length of the portion of the chain.

Preferably the links comprise holes and the chain holder comprises a projection to fit into one of the holes.

The apparatus may comprise a reel holder for holding a reel of the chain.

Optionally at least one of the pin disengager and the chain holder is a movable element movable to set the length.

Preferably position definers define discrete positions to which the movable element is movable. The position definers may comprise markings viewable by a user and/or comprise click-in mechanisms.

The apparatus may comprise an elongate structure. The pin disengager may be movable along the elongate structure.

The apparatus may comprise a joining tool for mutually connecting ends of the portion of the chain. The joining tool may be a rivet spinner. The chain may be chainsaw chain.

Another aspect of the invention provides a method of processing chain;
the chain comprising links mutually connected by pin portions;
the method comprising
   engaging the chain with a chain holder; and
   causing a pin disengager to remove one or more of the pin portions to disconnect a portion of the chain from a remainder of the chain;
wherein the pin disengager is positioned relative to the chain holder to define a length of the portion of the chain.

The links may comprise holes. The chain holder may comprise a projection. The method may comprise fitting one of the holes onto the projection.

The method may comprise withdrawing the chain from a reel. The method may comprise moving at least one of the pin disengager and the chain holder to adjust the length. The moving may be moving to a position definer and/or moving the pin disengager along an elongate structure.

The method may comprise mutually connecting ends of the portion of the chain.

### BRIEF DESCRIPTION OF DRAWINGS

FIG. 1 is a side view of a chain portion;

FIG. 2 is a perspective view of chain processing apparatus;

FIG. 3 is a perspective view of a reel held in the reel holding portion of the apparatus;

FIG. 4 is a perspective view of the chain breaking portion of the apparatus; and

FIG. 5 is a perspective view of the chain-holding portion of the apparatus.

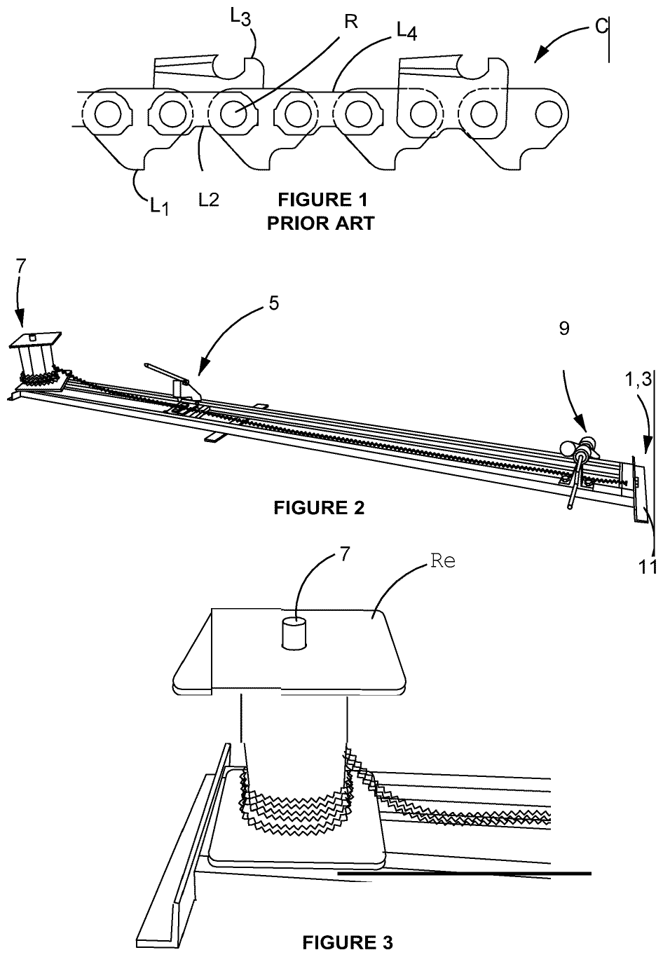

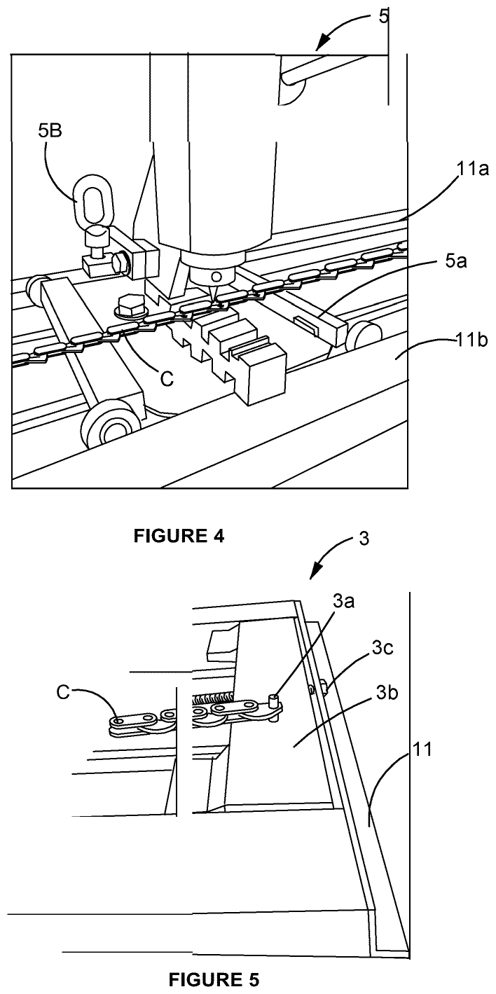

### DESCRIPTION OF EMBODIMENTS

The apparatus 1 comprises a chain holder 3, a pin disengager 5, a reel holder 7, a rivet spinner 9 and an elongate structure 11.

In this example, the elongate structure 11 takes the form of a pair of rails 11a, 11b mutually connected by cross pieces. The structure 11 is a chassis relative to which the components 3, 5, 7 are mounted. The rail(s) are preferably metallic, e.g. aluminium. Most preferably the rail(s) are extrusions.

The chain holder 3 is positioned at one end of the structure 11. The chain holder defines an anchor point against which the chain can be pulled to follow a defined path to the chain breaker 5. In this example, the path is a straight path although in other examples, the apparatus may comprise a guide system to guide the chain along another path. By way of example, the length of the apparatus might be reduced by an array of guide pins about which the chain might be zig-zagged.

The chain holder 3 could take a variety of forms. By way of example, it may include a clamping system to grip a portion of the chain or a profiled socket into which a link might be dropped. Most preferably the chain holder 3 comprises a projection in the form of a pin portion 3a configured to pass through a hole of the chain C. Most preferably the pin portion passes through a hinge hole of the chain (that is through a hole capable of accommodating a pin portion to mutually connect the link to another link).

The reel holder 7 comprises a post onto which a reel Re of chain can be placed. In this example, the chain holder 3 sits at one end of the structure 11 and the reel holder 7 sits at the other end of the structure 11.

This example of the pin disengager 5 is mounted on a carriage 5a that sits within, to ride along, the rails 11a, 11b whereby the pin disengager 5 is conveniently relocatable with respect to the chain holder 3. In the illustrated example, the carriage 5a comprises a respective circular bearing at each of its corners to roll along the rails. In another implementation, each rail may comprise a groove opening towards the other rail and the sides of the carriage may fit within to slide along these grooves. Whilst in these examples there are pairs of rails, other rail systems are possible. And yet other variants of the apparatus may do without rail(s).

By moving the pin disengager 5 it can be brought into register with the pin to be removed. In this example, the pin disengager comprises a clamping mechanism 5b that a user can screw down to clamp the carriage 5a onto the rail 11a and thereby fix the position of the pin disengager. Other means of fixation are possible.

In this example, the chain holder 3 is also movable with respect to the structure 11. The projection 3a projects upwardly from a body 3b mounted to move a short distance in the lengthwise direction and connected to the structure 11 via adjustment screw 3c. In this way, the carriage 5a provides a coarse adjustment and the screw 3c provides a finer adjustment, e.g. the chain can be pulled straight (or otherwise aligned with the desired path) and the carriage 5a positioned and clamped down in place (via clamp 5b). The chain can then be pulled straight (or otherwise aligned with the desired path) again to check the alignment of the chain breaker with the pin and if need be the screw 3c can be adjusted.

After this initial set up the pin disengager can be operated to remove the pin portion at one end of a pair of connecting links. The chain can then be advanced (i.e. pulled away from the reel) by one link and the pin disengager operated to disengage the pin portion at the other end of the pair of connecting links L₄ and leave a respective drive link L₁ at the free end of the reel and at the free end of a parted off portion of chain. Several similar lengths of chain can then be produced quickly and efficiently by withdrawing chain from the reel Re, engaging the free end of the chain with the chain holder 3a straightening (or otherwise aligning) the chain and operating the pin disengager 5. Preferred variants of the pin disengager simply push the pin portion out. Alternatively, the pin disengager might drill out the pin portion. The pin disengager might be configured to entirely remove the pin from the chain such as in the operation of a typical bicycle chainbreaker. Alternatively, the pin disengager may only disengage the target pin portion from a portion of the chain. In a typical chainsaw chain, a single pin portion skewers a pair of connecting lengths L₄ and a drive link L₁ sandwiched therebetween. Optionally, the pin disengager may take the form of a chainbreaker that disengages the pin from one of the connecting links and in doing so straightens the flared end of the pin to facilitate manual removal from the drive link. In this way, the parting off operation leaves (a) two free ends each ending in a drive link, (b) a connecting link still engaged with a pair of pin portions, and (c) a separate connecting link.

Whilst in principle, the initial position of the pin disengager 5 might be set by counting chain links, more preferably the apparatus is equipped within position-defining features. These features might take the form of markings that a user may take into account when moving the movable element(s) to set the length to be parted off. More preferably the device incorporates mechanical alignment aids. By way of example, the clamp 5b might be replaced by a vertical pin receivable within complementary holes along the rail 11a. More preferably the apparatus is equipped with a click-in mechanism, such as a ball detent or a ratchet mechanism so that a user can feel the pin disengager 5 (and/or other movable element) click into place as it reaches a defined position. By way of example, a mechanic caring for a fleet of chainsaws would benefit from an apparatus configured for the movable element to click into a set of positions each corresponding to a respective length of chain called for by the fleet.

The rivet spinner 9 is mounted in proximity to the chain holder 3. After the pin removal operation, the newly created free end of the chain portion is moved towards the chain holding/rivet spinning end of the apparatus. The two free ends of the parted off portion of chain are then mutually connected using a joining link. A joining link comprises (a) one member defining a connecting link L₄ and equipped with two pin portions, and (b) a second connecting link. The pin portions are inserted through the hinge holes of the exposed drive links and then through a respective hole at each end of the second connecting link. The ends of these pin portions are then deformed by the rivet spinner 9 to prevent reversal and thereby form a continuous loop of saw chain for use in the chainsaw.

The invention is not limited to the examples disclosed herein. Rather the invention is defined by the claims. Some variants of the technology may be usefully employed in the context of chains other than chainsaw chains such as roller chains (e.g. bicycle chains) and leaf chains. Some chains, e.g. bicycle chains, can be joined without a rivet spinner, e.g. by simply pressing a pin in place or by using a quick link. Likewise whilst apparatus adjustable to produce chain portions of differing lengths are disclosed, non-adjustable variants may be useful in some contexts.

The term ‘comprises’ and its grammatical variants has a meaning that is determined by the context in which it appears. Accordingly, the term should not be interpreted exhaustively unless the context dictates so. Likewise, the article “a” or “an” preceding an element does not exclude the presence of a plurality of such elements unless the context dictates so.

1-19. (canceled)

20. An apparatus for processing chain;
the chain comprising links mutually connected by pin portions;
the apparatus comprising
a chain holder to hold an end of the chain and define an anchor point against which the chain can be pulled; and
a pin disengager operable to disengage one or more of the pin portions for disconnecting a portion of the chain from a remainder of the chain;
wherein the pin disengager is positioned, or positionable, at a relative position relative to the anchor point, and such that the relative position defines a length of the portion of the chain;
at least one of the pin disengager and the chain holder is a movable element mounted to move to set the length; and
the apparatus comprises position definers defining discrete positions to which the movable element is movable.

21. The apparatus of claim 20, wherein the position definers comprise markings viewable by a user.

22. The apparatus of claim 20, wherein the position definers comprise click-in mechanisms.

23. The apparatus of claim 20, wherein the links comprise holes and the chain holder comprises a projection to fit into one of the holes.

24. The apparatus of claim 20, comprising a reel holder for holding a reel of the chain.

25. The apparatus of claim 20, comprising an elongate structure; and
wherein the pin disengager is movable along the elongate structure.

26. The apparatus of claim 20, comprising a joining tool for mutually connecting ends of the portion of the chain.

27. The apparatus of claim 26, wherein the joining tool is a rivet spinner.

28. The apparatus of claim 20, wherein the chain is chainsaw chain.

29. A method of processing chain;
the chain comprising links mutually connected by pin portions;
the method comprising
engaging an end of the chain with a chain holder defining an anchor point against which the chain can be pulled; and
causing a pin disengager to disengage one or more of the pin portions for disconnecting a portion of the chain from a remainder of the chain;
wherein the pin disengager is mounted, at a relative position relative to the anchor point, such that the relative position defines a length of the portion of the chain.

30. The method of claim 29, wherein the links comprise holes;
the chain holder comprises a projection; and
the method comprises fitting one of the holes onto the projection.

31. The method of claim 29, comprising withdrawing the chain from a reel.

32. The method of claim 29, comprising moving at least one of the pin disengager and the chain holder to adjust the length.

33. The method of claim 32, wherein the moving is moving to a position definer.

34. The method of claim 32, wherein the moving is moving the pin disengager along an elongate structure.

35. The method of claim 29, comprising mutually connecting ends of the portion of the chain.

36. The method of claim 29, wherein the chain is chainsaw chain.

37. The method of claim 33, wherein the position definer is a marking viewable by a user.

38. The method of claim 33, wherein the position definer comprises a click-in mechanism.
